(19) United States
(12) Patent Application Publication
(10) Pub. No.: US 2019/0337476 A1
(43) Pub. Date: Nov. 7, 2019

(54) Radius Bumper with Accessory Mount and Method of Construction

(71) Applicant: Addictive Desert Designs, LLC, Mesa, AZ (US)

(72) Inventors: Jared Hare, Mesa, AZ (US); Gregory L. Foutz, Mesa, AZ (US); Daniel M. Bohler, Mesa, AZ (US); Doug Hare, Mesa, AZ (US)

(73) Assignee: Addictive Desert Designs, LLC, Mesa, AZ (US)

(21) Appl. No.: 16/403,504

(22) Filed: May 4, 2019

Related U.S. Application Data
(60) Provisional application No. 62/667,160, filed on May 4, 2018.

(51) Int. Cl. B60R 19/48

(52) U.S. Cl. CPC B60R 19/48

(57) ABSTRACT

A bumper construction composed from one or more plates of metal that are rounded or bent to form the bumper construction or portions of the construction, and then joined to form the final bumper construction having an accessory cavity.

### FIELD OF THE INVENTION

The present invention relates to bumpers for vehicles, and in particular, aftermarket bumpers including an accessory mount for accessories such, but not limited to, aftermarket lighting, cameras, or speakers.

### BACKGROUND OF THE INVENTION

Vehicles may be equipped with aftermarket bumpers and accessories to improve the appearance or utility of a vehicle. For example, an aftermarket bumper and accompanying accessory such as lighting may be available from manufacturers in the form of a light-bar comprised of multiple light units, attached to or within, a housing that is mountable to the vehicle body, or individual lighting units that must be separately mounted to the vehicle body. Mounting lighting as described however, requires alteration of the vehicle body, which can void warranties, be difficult for most vehicle owners, or be cost prohibitive if the vehicle owner chooses to pay a third party installer to attach the lighting accessory. Further adding to the difficulty is the differing dimensions of accessories and the associated mounting hardware and/or requirements of the accessories from different manufactures. Accordingly, there is a need for an improved accessory mount structure or system that accommodates many alternately designed and dimensioned aftermarket accessories and the associated mounting requirements.

### SUMMARY OF THE INVENTION

Aspects of the disclosure may be incorporated in a bumper construction with an accessory cavity and having a radius that curves around the front of a vehicle to which it is attached. The curve of the bumper radius may be from a composition of flat metal plate portions or formed from a smooth bending of the forward facing bumper portions. In certain constructions the bumper is comprised of a plurality of metal plate portions including a first metal plate portion comprising a first metal plate portion bottom edge, a second metal plate portion comprising a second metal plate portion top edge and a second metal plate portion side edge, with the first metal plate portion and second metal plate portion connected along the first metal plate portion bottom edge and the second metal plate portion top edge; and a first metal plate lateral portion having a first metal plate lateral portion edge connected along the first metal plate lateral portion edge and the second metal plate portion side edge; and with an accessory cavity opening framed by the second metal plate portion. Moreover, the construction may be of the nature wherein the first metal plate portion, second metal plate portion, and first metal plate lateral portion, are formed from a single metal sheet.

Aspects are also embodiments wherein the first metal plate portion and the second metal plate portion are connected along a bend comprising the first metal plate portion bottom edge and the second metal plate portion top edge; or wherein the first metal plate lateral portion edge is connected along a bend comprising the first metal plate lateral portion edge and the second metal plate portion side edge; or wherein the accessory cavity is positioned rearward of the second metal plate portion and beneath the first metal plate portion. In such embodiments the first metal plate portion and the second metal plate portion oriented at an angle between about 45 and 90 degrees, or wherein the second metal plate portion side edge angles outward from the second metal plate portion top edge.

Aspects may include a bumper construction with a gap between the second metal plate portion and the first metal plate lateral portion, and wherein during assembly the second metal plate portion and the first metal plate lateral portion are joined together and an angle to close the gap. In such embodiments, the first metal plate lateral portion angles backward relative to a vehicle to which the bumper construction is attachable.

Aspects may include that the second metal plate portion has a second metal plate portion width and a second metal plate portion length and the second metal plate portion includes at least one bend extending across the second metal plate portion width. Alternatively, the first metal plate portion may have a first metal plate portion width and a first metal plate portion length and the first metal plate portion includes at least one bend extending across the first metal plate portion width. Aspects may also include a bumper construction wherein the at least one bend extending across the first metal plate portion width aligns with the at least one bend extending across the second metal plate portion width.

Aspects may also be embodied in an accessory mount comprising an accessory mounting base that is coupled to the second metal plate portion. Or, the accessory mount may comprise a substantially flat longitudinal plate that is connected substantially parallel to the second metal plate portion.

Numerous other advantages and features of the present invention will become readily apparent from the following detailed description of the invention and the embodiments thereof, from the claims and from the accompanying drawings.

### BRIEF DESCRIPTION OF THE DRAWINGS

The figures illustrate embodiments incorporating certain aspects of the invention.

FIG. 1 illustrates a first embodiment including aspects of the disclosure;

FIG. 2 illustrates half of a first forward facing assembly of the first embodiment that includes aspects of the disclosure;

FIGS. 2-5 illustrate a sequence of assembling the half of the first forward facing assembly of the first embodiment by bending several metal plate portions of the forward facing first half assembly;

FIG. 6 illustrates a second embodiment including aspects of the disclosure;

FIG. 7 illustrates a top view of the second embodiment;

FIGS. 8-13 illustrate a sequence of assembling a second forward facing assembly by bending several metal plate portions of the forward facing assembly;

FIGS. 14-18 illustrates a third embodiment including a third forward facing assembly that omits bends present in the forward facing assembly of the first and second embodiments; and

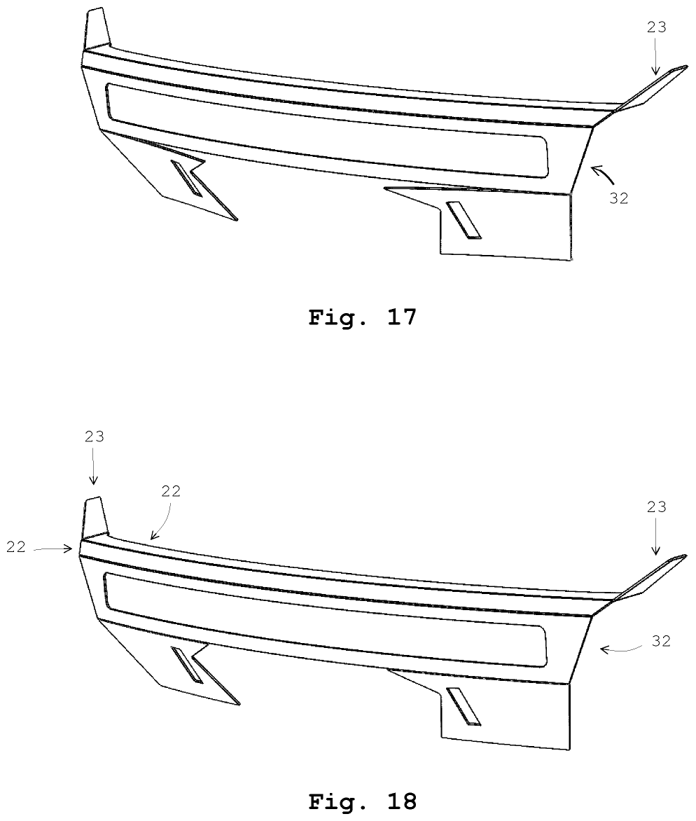

FIGS. 19-20 illustrate perspective and top views, respectively of the third embodiment.

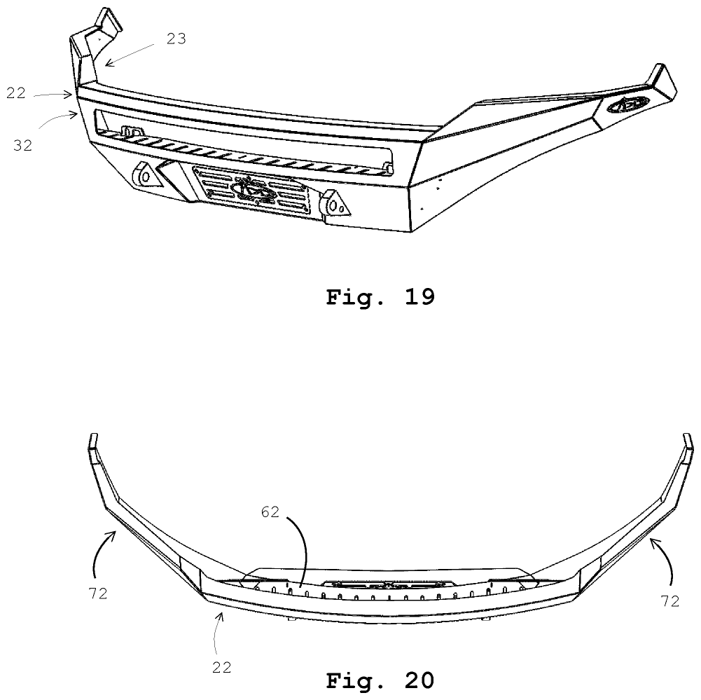

The objects, features and advantages of the present invention will be more readily appreciated upon reference to the following disclosure when considered in conjunction with the accompanying drawings, wherein reference numerals are used to identify the components in the various views.

### DESCRIPTION OF PREFERRED EMBODIMENTS

The figures illustrate an embodiment of a bumper construction according to the description and claims that follow. In general, bumper construction is adaptable and modularly constructed to be fixed to any of a variety of vehicle frames or exteriors. The modular construction of the bumper construction facilitates complimenting or matching many of the varieties of contours or shapes that may be found on a vehicle exterior.

The bumper construction described herein can be configured or constructed to match the curve, shape, or design of the vehicle body. As an example, the bumper construction described can be configured or constructed to match the curve, bow, styling, or design of the vehicle front and match, compliment, or augment the utility or aesthetics of the vehicle front by attachment of the bumper construction alone or by the further attachment of aftermarket accessories such as, but not limited to, lighting, speakers, or cameras within the protected accessory cavity described. Alternate configurations of the accessory mount are constructed for alternate vehicle body designs or aftermarket vehicle accessory designs and each configuration is achievable with the teachings and description herein or with modest modifications thereof. The flexibility and modularity of the bumper construction or manufacture permits that various shapes, contours, or dimensions can be matched to various vehicle body shapes or aftermarket vehicle accessory shapes and sizes.

The general bumper construction or manufacture may be a composition of several or a plurality of metal plate portions wherein certain of the portions are respectively connected along the edges and at various angles to form the bumper construction. A first preferred embodiment of the bumper construction may be a composition of substantially flat metal plate portions wherein certain of the portions may be connected along edges and at angles to form the bumper construction A second preferred embodiment of the bumper construction may be a composition of smooth curved metal plate portions wherein certain of the portions may be connected along edges and at angles to form the bumper construction. Yet another embodiment of the bumper construction may be a combination of substantially flat metal plate portions and smooth curved metal plate portions wherein certain of the portions may be connected along edges and at angles to form the bumper construction.

Each of the substantially flat metal plate portions or curved metal plate portions may comprise a single formed sheet of metal or each substantially flat metal plate portion may be formed by bending a larger sheet of metal to form two or more substantially flat metal plate portions that may be left flat or that may be formed into a curved plate portion. The metal plate portions preferably comprise polygonal, hexagonal or octagonal shaped portions and in preferred embodiments the bumper construction are formed or manufactured by creasing, folding, or bending the metal plate portions where appropriate to form substantially planer and distinct metal sheet sub portions of the bumper construction. Further, the bumper construction may be made in portions; such has right and left half portions, and then joined together along the edges such as by welding to create the final bumper construction. Finally, preferred bumper constructions may incorporate an accessory cavity extending rearward from the bumper construction front surface and therefore partly shielded or concealed by the most forward (relative to the vehicle body) sub portion(s) of the bumper construction.

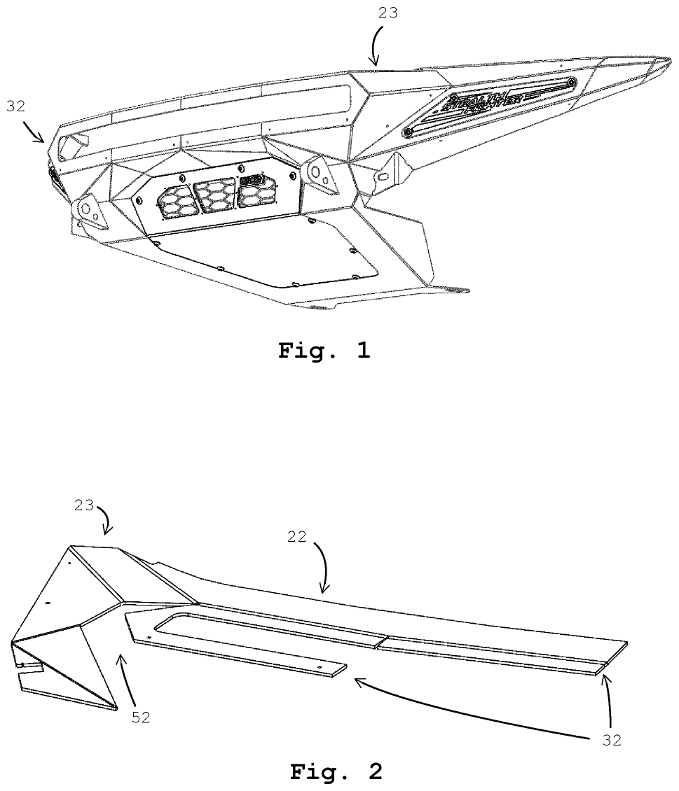

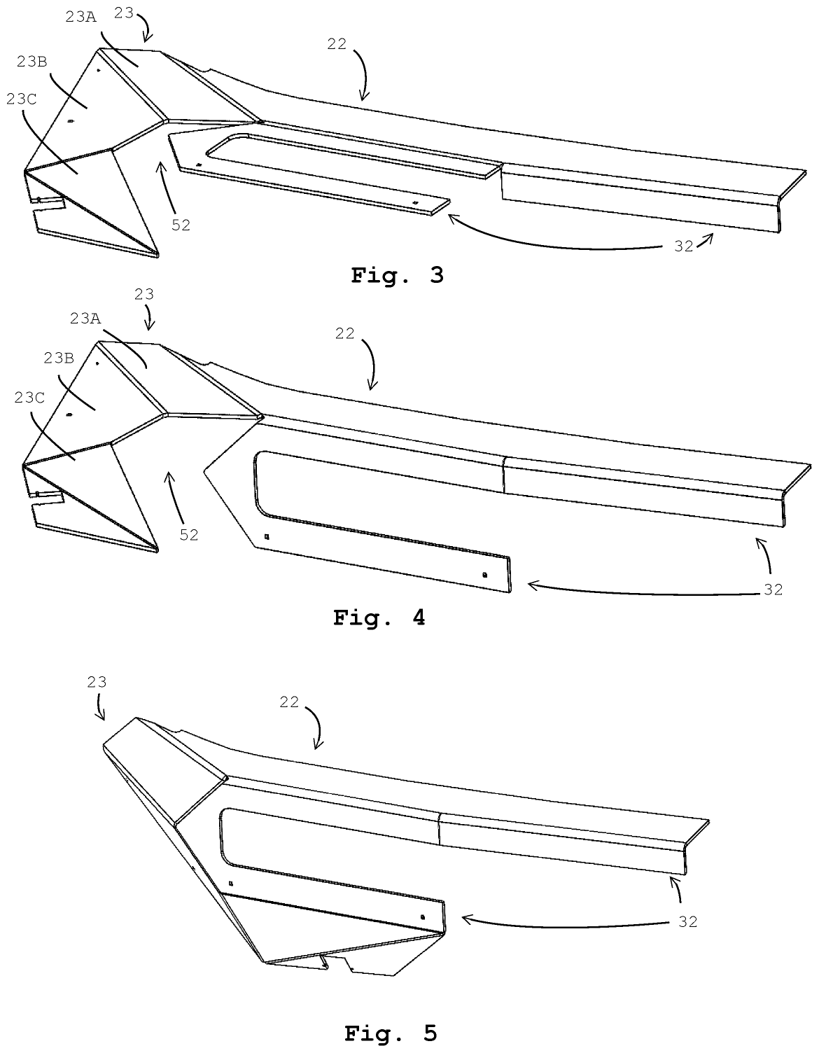

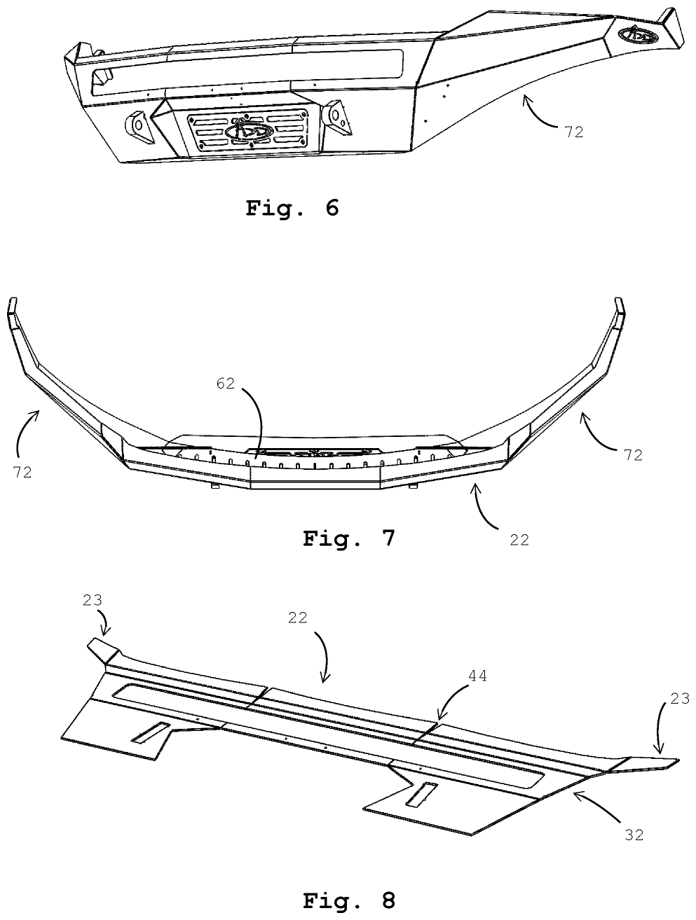

A preferred embodiment for a bumper construction according to the description comprises a substantially flat metal plate article of manufacture that is formed or bent to form several distinct metal plate portions during manufacture of the resulting bumper. A first embodiment is illustrated in FIGS. 1-6, which show a bumper construction having the features described herein and made in the manner described herein. The bumper is constructed from a single metal plate from which at least first and second substantially flat metal plate portions are formed. The bumper may be constructed in modular form and subsequently joined such as by welding to create the final bumper construction. Moreover, when the finished bumper is attached to a vehicle, a first metal plate portion 22 extends laterally away from a position just adjacent to a vehicle body and a second metal plate portion 32 is positioned substantially vertically relative to the vehicle body creating an accessory cavity there behind. Finally, at least one first metal plate lateral portion 23 angles rearward relative to the vehicle body.

The first metal plate portion 22 has a first metal plate lateral bottom edge and the second metal plate portion 32 has a second metal plate lateral top edge and the first metal plate lateral edge is connected to the second metal plate lateral top edge substantially along the first metal plate lateral bottom edge. A bend line, crease, or segment between the first metal plate portion 22 and the second metal plate portion 32 delineates the portions and denotes the crease or fold upon which the single metal plate has been bent to create the respective metal plate portions. Reliefs, notches, or gaps 52, are cut into the composite metal plate from which the first metal plate portion 22 and second metal plate portion 32 to allow relative angled orientations between adjacent plate portions. In the first embodiment, the first metal plate portion 22, the second metal plate portion 32, and first metal plate lateral portion 23 are formed from a metal plate that is laser cut to form a shape formed by exterior edges of the respective metal plate portions and that is subsequently bent to form the distinct plate portions.

A sequence of several steps of a bumper construction is illustrated in FIGS. 4-6. The metal plate is cut to include the first metal plate portion 22, the second metal plate portion 32, and the first metal plate lateral portion 23, with a gap 52 between the first metal plate lateral portion 23 and the second metal plate portion 32. The first metal plate lateral portion 23 may be further comprised of first 23A, second 23B, and third 23C portions with a bend positioned between the first 23A and second 23B portions, and a bend positioned between the second 23B and third 23C portions, thereby creates the surfaces of the first 23A, second 23B, and third 23C portions that are angled relative to each other and connectable, such as by welding, to the second metal plate portion 32, which includes an angled or smooth side angle that is complementary to the angled created between the second 23B, and third 23C portions of the first metal plate lateral portion 23. The first metal plate portion 22 has a bend along the side edge shared with the first metal plate lateral portion 23, wherein the bend forms an obtuse angle relative to the bend between the first metal plate portion 22 and the second metal plate portion 32. A bend of the metal plate along this segment at an obtuse angle causes the surfaces of the surfaces of the first 23A, second 23B, and third 23C portions to angle rearward and inward relative to both the second metal plate portion 32 and the vehicle front to which the bumper will be attached, and fill in the gap 52 between the first metal plate lateral portion 23 and the second metal plate portion 32 when the first metal plate lateral portions 23A, 23B, and 23C, are bent as shown in FIGS. 4 and 5. The metal plate is also bent at the shared edge between the first and second metal plate portions, 23 and 32, such that the respective portions become angled relative to the other along the line or segment 42 between the portions. And, as illustrated, the second metal plate portion 32 may further comprise upper and lower lateral surfaces that frame the opening of an accessory cavity rearward of the second metal plate portion 32, wherein the accessory cavity is bounded by the first metal plate portion 22, the second metal plate portion 32, and the first metal plate lateral portions 23A, 23B, and 23C. The bumper construction is attachable to a vehicle exterior and accessories, such as lighting, are attachable to the bumper construction inside of the accessory cavity rearward of the second metal plate 32 and laterally away from the vehicle exterior.

Further, the bumper construction may be made in two or more portions and joined together to form the final bumper construction that is attachable to a vehicle. As one example, the illustrations show a bumper construction comprised of a first half bumper portion of a whole bumper construction and a second half portion of the whole bumper, wherein the second half portion mirrors the first half bumper portion. The first half portion is then connected to the second half portion such as by welds. As an example, the first metal plate portion 22, the second metal plate portion 32, and first metal plate lateral portion 23 comprise a left half portion of a whole bumper construction, or a first metal plate left portion 22A, a second metal plate left portion 32A, and a first metal plate lateral left portion 23A, respectively. A right half portion of the whole bumper construction comprises complementary first metal plate and second metal plate portions, 22B and 32B, respectively and a complementary flexion segment 42B, each connected on a side edge to the first metal plate portion 22B, and the second metal plate portion 32B, of the whole bumper first half portion, respectively.

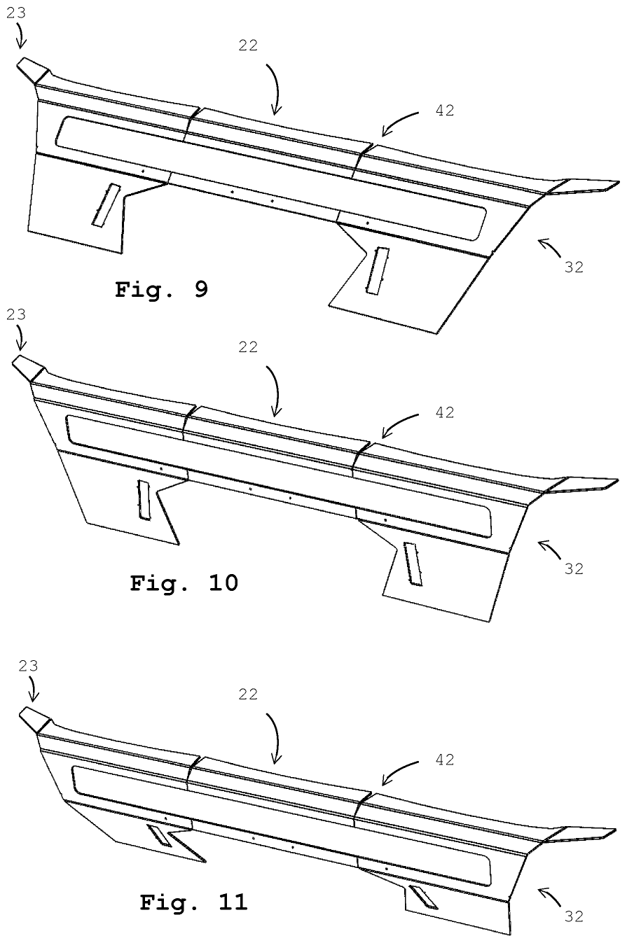

As an example, another embodiment is illustrated in FIG. 6 wherein the second metal plate portion 32 comprises a left (or right) portion that is subdivided to comprise outer and inner second metal plate portion segments, 32A′ and 32A″ and 32B′ and 32B″ wherein a flexion segment delineates each metal plate portion as illustrated and such that each metal plate portion is no longer in the same plane as another metal plate portion but may have an angle relative to other metal plate portions that is less than 90 degrees.

The accessory cavity is preferably integrated into the bumper construction at or rearward of the second metal plate portion 32. In one preferred embodiment the second metal plate portion 32 has a rectangular opening wherein the opening is formed from top and bottom substantially rectangular segments that transition to each other on the outer outside ends. In preferred embodiments the second metal plate 32 is connected along and to the first metal plate 22 by the bend. Alternatively, if the bumper construction is constructed in portions the top and bottom substantially rectangular segments are connected on the outside ends of each of the second metal plate first and second portions 32A and 32B, and the top substantially rectangular segments of the second metal plate left and right portions 32A and 32B joined at and along the inside ends, and the bottom substantially rectangular segments of the second metal plate first and second portions 32A and 32B joined at and along the inside ends. Moreover, the second metal plate portions 32A and 32B are preferably connected at outside ends such that the second metal plate portion 32A connection to the second metal plate portion 32B is a contiguous connected curve between the portions and that the transition between the respective portions is not a clear or delineation such as a weld or bend but rather a smooth transition between top and bottom substantially rectangular segments that are formed from the same portion of metal plate used to construct or form the second metal plate portion 32.

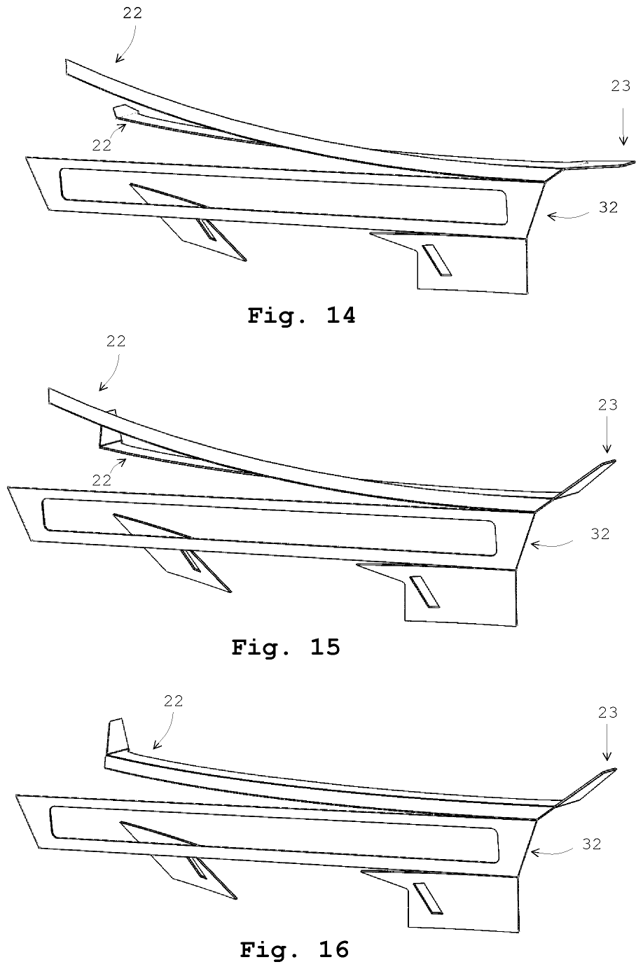

A second preferred embodiment is illustrated in FIGS. 6-13. Formation of the accessory cavity again comprises a first metal plate portion 22 coupled to a second metal plate portion 32 and a first metal plate lateral portion 23. The first metal plate portion 22 may be further laterally sub divided or sub portioned, 22A, 22B, and 22C, (as illustrated) by bends in the first metal plate portion 22, each relief 44 comprising a wedge cut into the first metal plate portion 22, to facilitate bending of the first metal plate portion 22 to form a bumper portion having an arc. Similarly, the second metal plate portion 32 may be further laterally sub divided or sub portioned, 32A, 32B, and 32C, at the reliefs 44, to facilitate bending of the second metal plate portion 32.

A bend between the first metal plate portion 22 and the second metal plate portion 32 delineates the portions and denotes the crease or fold upon which the single metal plate has been bent to create the respective metal plate portions. Reliefs, notches, or gaps 52, are cut into the composite metal plate from which the first metal plate portion 22 and second metal plate portion 32 to allow relative angled orientations between adjacent plate portions.

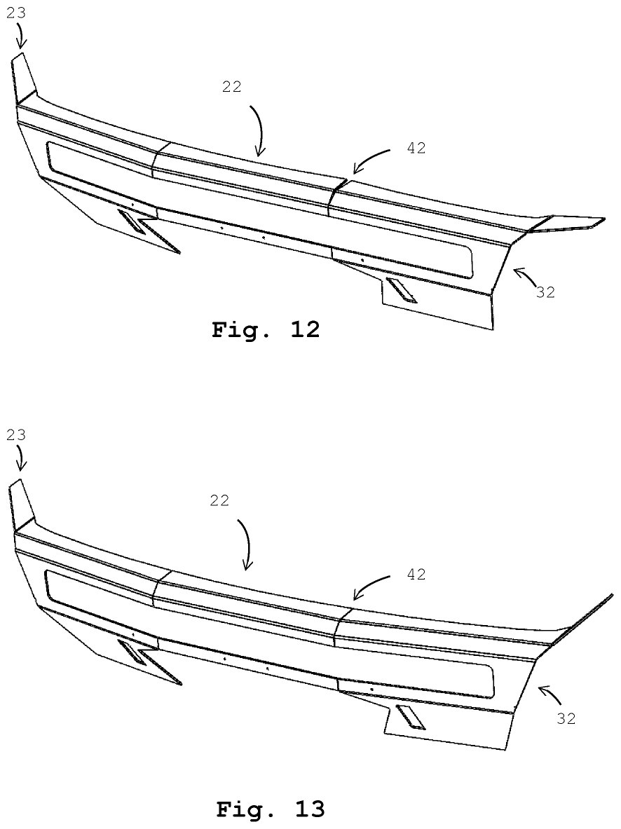

The accessory cavity preferably includes an accessory mounting base 62 attached rearward of, and substantially perpendicularly to, the second metal plate portion. See FIG. 7. A preferred accessory mounting base 62 comprises a substantially flat longitudinal plate that is connected substantially parallel to the length of the bottom substantially rectangular segment of the second metal plate portion. The accessory mounting base also preferably includes base mounting slots to facilitate the mounting of accessories to the mounting base. Each base mounting slot may be comprised of at least one, but preferably two arcs, with each arc on alternate ends of an otherwise rectangular or slot-shaped aperture that extends through the base mounting slot. Each base mounting slot may have an arc radius of about 0.1 cm to about 2 cm but are preferably about 0.19 cm and the distance between adjacent base mounting slot centers may be between about 2 cm and 8 cm but are preferably about 3 cm to 6 cm as measured a long a line or arc between base mounting slot centers. Mounting brackets may be connected to the accessory mounting base at one or more of the mounting slots by fastening hardware such as nuts and bolts.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A bumper construction, comprising:
a first metal plate portion comprising a first metal plate portion bottom edge;
a second metal plate portion comprising a second metal plate portion top edge and a second metal plate portion side edge, the first metal plate portion and second metal plate portion connected along the first metal plate portion bottom edge and the second metal plate portion top edge; and
a first metal plate lateral portion having a first metal plate lateral portion edge connected along the first metal plate lateral portion edge and the second metal plate portion side edge; and
an accessory cavity opening framed by the second metal plate portion;
wherein the first metal plate portion, second metal plate portion, and first metal plate lateral portion, are formed from a single metal sheet.

2. The bumper construction in claim 1 wherein,
the first metal plate portion and second metal plate portion connected along a bend comprising the first metal plate portion bottom edge and the second metal plate portion top edge.

3. The bumper construction in claim 2 wherein,
the first metal plate lateral portion edge is connected along a bend comprising the first metal plate lateral portion edge and the second metal plate portion side edge.

4. The bumper construction in claim 3 wherein,
the accessory cavity is positioned rearward of the second metal plate portion and beneath the first metal plate portion.

5. The bumper construction in claim 1 wherein,
the first metal plate portion and the second metal plate portion are oriented at an angle between about 45 and 90 degrees.

6. The bumper construction in claim 1 wherein,
the second metal plate portion side edge angles outward from the second metal plate portion top edge.

7. The bumper construction in claim 1 further comprising,
a gap between the second metal plate portion and the first metal plate lateral portion, wherein during assembly the second metal plate portion and the first metal plate lateral portion are joined together and an angle to close the gap.

8. The bumper construction in claim 7 wherein,
the first metal plate lateral portion angles backward relative to a vehicle to which the bumper construction is attachable.

9. The bumper construction in claim 2 wherein,
the second metal plate portion has a second metal plate portion width and a second metal plate portion length and the second metal plate portion includes at least one bend extending across the second metal plate portion width.

10. The bumper construction in claim 9 wherein,
the first metal plate portion has a first metal plate portion width and a first metal plate portion length and the first metal plate portion includes at least one bend extending across the first metal plate portion width.

11. The bumper construction in claim 10 wherein,
the at least one bend extending across the first metal plate portion width aligns with the at least one bend extending across the second metal plate portion width.

12. The bumper construction in claim 9 wherein,
an accessory mount comprising an accessory mounting base is coupled to the second metal plate portion.

13. The bumper construction in claim 12 wherein,
the accessory mount comprises a substantially flat longitudinal plate that is connected substantially parallel to the second metal plate portion.

14. A bumper construction, comprising:
a forward facing assembly and left and right metal plate portions;
the forward facing assembly comprised of first metal plate portion, a second metal plate portion, and a first metal plate lateral portion, the first metal plate lateral portion comprised of a first metal plate portion bottom edge, the second metal plate portion comprised of a second metal plate portion top edge, and the first metal plate lateral portion comprised of a first metal plate lateral portion edge, the first metal plate portion and second metal plate portion connected along a bend comprising the first metal plate portion bottom edge and the second metal plate portion top edge, the first metal plate lateral portion edge is connected along a bend comprising the first metal plate lateral portion edge and the second metal plate portion side edge;
the left and right metal plate portions, coupled to at least two of the first metal plate portion, the second metal plate portion, and first metal plate lateral portion, respectively;
wherein the forward facing assembly is formed from a single sheet of metal and joined to the left and right metal plate portions.

15. The bumper construction in claim 14 wherein,
the accessory mount comprises a substantially flat longitudinal plate that is connected substantially parallel to the second metal plate portion.

16. The bumper construction in claim 14 wherein,
the left and right metal plate portions are each formed from single sheets of metal.
